(19) United States
(12) Patent Application Publication
(10) Pub. No.: US 2012/0055601 A1
(43) Pub. Date: Mar. 8, 2012

(54) PROGRESSIVE TIRE MOLD ELEMENT WITH SCALLOPS AND TIRE FORMED BY THE SAME

(75) Inventor: Damon L. Christenbury, Fountain Inn, SC (US)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 13/319,344

(22) PCT Filed: Jun. 12, 2009
(86) PCT No.: PCT/US2009/047139

§ 371 Date: Nov. 8, 2011

(51) Int. Cl. B60C 11/12; B29D 30/06

(52) U.S. Cl. 152/209.18; 425/54

(57) ABSTRACT

Particular embodiments of the present invention include a progressive sipe mold member with scallops and a corresponding sipe formed within a tire tread. In a particular embodiment, the present invention includes a progressive sipe mold member for use in a mold, the mold member comprising: an upper mold member extending downwardly from a top end to a bottom end; and, a first lower projection member and a second lower projection member, each lower member extending downward from the upper mold member and having recesses on their inward and outward facing surfaces. The sipe mold member may also have a sweep axis along which the sipe mold member undulates in a desired path as well as an undulation in the upper mold member. The mold member creates a sipe in the tread of a tire that has the negative image of the shape of the mold member.

### BACKGROUND OF THE INVENTION

1. Field of the Invention

This invention relates generally to tire treads and molds, and, more specifically, to scalloped, progressive tread sipes for tires and methods and apparatus of forming the same.

2. Description of the Related Art

It is commonly known for tire treads to contain various tread elements and features to enhance tire performance. It is also commonly known that these elements and features may be formed within a mold during a curing process. Treads may be formed and cured independently, such as for retreading, or concurrently with an attached tire carcass. Therefore, the term “molding” or “mold” within this application including the claims is to be understood to include retreading techniques and apparati as well as standard molding techniques and apparati.

Grooves and sipes are two common tread features that are formed within a tread. Grooves are troughs formed within the tread to form tread elements, such as ribs and blocks. Sipes are very thin extensions that generally extend within the tread elements. Grooves provide void within the tread for the consumption of water and other substances encountered by the tire. Grooves also provide surface edges to improve tire traction. Sipes also provide traction edges, while further reducing tread element stiffness. Sipes, however, achieve their purposes generally without materially increasing the tread void. This is because sipes are very thin extensions, which, for conventional straight sipes, are typically 0.2-0.6 millimeters (approximately 0.008-0.024 of an inch) thick; however, sipes can measure upwards of 1.0-1.2 mm thick (approximately 0.040-0.048 of an inch). It is desirous, however, to provide sipes that are as thin as possible to minimize the formation and existence of void.

Progressive sipes generally provide an upper sipe portion extending from an outer surface of the tread to a particular depth within the tread, after which a pair of lower sipe projections (or legs) extend downwardly into the tread from the first portion. At least one of the lower projections also extends outwardly from the other while extending into the tread depth. Generally, progressive sipes appear in cross-section as an inverted “Y”, such as is generally shown in U.S. Pat. No. 4,994,126. When molding a tire tread, a mold form or member is used to create a progressive sipe in such tread, where such mold member provides the cross-sectional shape of the sipe to be created. Because progressive sipes have outwardly extending projections, progressive sipe mold members contain similar projections. Accordingly, corresponding mold members generally experience elevated loads during molding and demolding operations due to the existence of the lower projections. During such operations, sipe mold members are forced into the tread during mold closure and out of the tread during mold opening. Accordingly, a progressive sipe mold member must be durable enough to withstand the loadings observed during molding and demolding operations, as well as for repeated use for multiple curing cycles.

One approach for providing a more durable progressive sipe mold member is to increase the thickness of each portion of the form corresponding to the various portions and projections of the sipe mold member. This, however, results in thicker sipes, which may not be optimum for tire performance. Accordingly, there is a need for a more durable progressive sipe mold member, which provides sufficiently thin sipes in a tire tread.

On the other hand, while it is desirable that a sipe increases the flexibility of a tread element when the tread element enters or exits a contact patch (so called because this is where the tire contacts the road), it also desirable that a sipe be able to lock up when the tread element is in the contact patch, such that the tread element becomes as stiff as possible. This improves the handling and rolling resistance of the tire. Accordingly, there is also a need for a progressive sipe mold member, which provides means for creating a sipe in a tire that enhances the stiffness of a tread element once it is in the contact patch. Unfortunately, there is typically a design tradeoff between improved molding and demolding of sipes and enhanced block or rib stiffness as design features that improve block or rib stiffness involve some sort of undercut and/or increased surface area which inherently creates more friction, making molding and demolding the sipe more difficult. Therefore, there is a need to find a solution that decouples this design compromise and allows a rib or block with more rigidity to be provided by a progressive sipe that can still be satisfactorily molded and demolded.

### SUMMARY OF THE INVENTION

Particular embodiments of the present invention include tires with treads containing one or more progressive sipes that have means for enhancing the stiffness of a tread element when it is in the contact patch, as well as methods and apparatus for forming such in treads. Particular embodiments of the present invention include a sipe mold member for use in a mold. Particular embodiments of such mold member include an upper mold member extending downwardly from a top end to a bottom end. Particular embodiments may also include a first lower projection member and a second lower projection member, each lower member extending downward from the upper mold member and having a outward facing surface and inward facing surface. Further, particular embodiments provide that the first lower projection member has outward and inward facing surfaces with recesses thereon.

In other embodiments, the recesses on the outward facing surface and inward facing surface of the first lower projection have an alternating pattern with at least one recess on one surface being found in between two recesses located on the other surface. In addition, the recesses may have at least one sloped surface found in their interior to help the demolding of the sipe mold member. The mold member may have a sweep axis along which the sipe mold member undulates in a desired path. Also, the upper mold member may also undulate.

Particular embodiments of the present invention include a tire with a molded tire tread including a plurality of tread elements being separated by one or more grooves, and having one or more progressive sipes within a tread element. In particular embodiments, each such sipe includes a first and second lower sipe projection extending from an upper sipe portion, each of the projections being spaced apart from the other within the tread and extending to a depth within the tread with said first and second lower sipe projections having opposing sidewalls, said first lower sipe projection having ridges on its opposing sidewalls.

In other embodiments, the ridges on the opposing sidewalls of the first lower projection have an alternating pattern with at least one ridge on one sidewall being found between two ridges located on the other sidewall. In addition, the progressive sipes of the tire may have a sweep axis along which the sipe undulates in a desired path. In certain instances, the upper sipe portion includes opposing sidewalls that undulate.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1A is a top oriented perspective view of a progressive sipe mold member having scallops and no undulations along its sweep axis in accordance with an embodiment of the present invention;

FIG. 1B is a top oriented perspective view of a progressive sipe mold member having scallops and undulations along its sweep axis in accordance with an embodiment of the present invention;

FIG. 1C is a top oriented perspective view of a progressive sipe mold member having scallops, undulations along its sweep axis and undulations along its upper member in accordance with an embodiment of the present invention;

FIG. 1D is a bottom oriented perspective view of the mold member of FIG. 1A showing the scallops found on the inward facing surfaces of the mold member;

FIG. 1E is a bottom oriented perspective view of the mold member of FIG. 1B showing the scallops found on the inward facing surfaces of the mold member;

FIG. 1F is a bottom oriented perspective view of the mold member of FIG. 1C showing the scallops found on the inward facing surfaces of the mold member;

FIG. 2A is an end view of the mold member of FIG. 1A showing forces acting on such a member during the closing of a mold prior to a curing cycle;

FIG. 2B is an end view of the mold member of FIG. 1A showing forces acting on such a member during the opening of a mold subsequent a curing cycle;

FIG. 2C is an end view of the mold member of FIG. 1C showing forces acting on such a member during the closing of a mold prior to a curing cycle;

FIG. 3A is a front cross sectional view of the mold member of FIG. 1B taken along line 3A-3A thereof showing the geometry of the scallops more clearly;

FIG. 3B is a top cross sectional view of the mold member of FIG. 1B taken along line 3B-3B thereof showing the alternating pattern of the scallops more clearly;

FIG. 4 is a top view of the mold member of FIG. 1B;

FIG. 5 is a top view of a non-symmetrically undulating sipe mold member, in accordance with an alternative embodiment of the invention;

FIG. 6 is a top view of an undulating sipe mold member extending in a stepped path, in accordance with an alternative embodiment of the invention;

FIG. 7 is a top view of an undulating sipe mold member extending along an arcuate sweep axis, in accordance with an alternative embodiment of the invention;

FIG. 8A is a perspective view of a tread having a plurality of sipes, in accordance with an embodiment of the present invention shown in FIG. 1A;

FIG. 8B is a perspective view of a tread having a plurality of undulating sipes, in accordance with an embodiment of the present invention shown in FIG. 1B;

FIG. 8C is a perspective view of a tread having a plurality of undulating sipes, in accordance with an embodiment of the present invention shown in FIG. 1C;

FIG. 8D is an enlarged view of a sipe of the tread of FIG. 8C;

FIG. 8E is a top cross sectional view of the lower projection of the sipe shown in FIG. 8D taken along line 8E-8E thereof illustrating the arrangement of the ridges within the sipe;

FIG. 9A is a sectional view of a sipe contained within a tread in accordance with an embodiment of the invention with undulations shown on the upper member of the sipe;

FIG. 9B is a cross-sectional view of an alternative undulating sipe, in accordance with an alternative embodiment of the invention with no undulations shown on the upper member of the sipe;

FIG. 9C is a cross-sectional view of an alternative undulating sipe, in accordance with an alternative embodiment of the invention with undulations shown on the upper member of the sipe;

FIG. 9D is a cross-sectional view of an alternative undulating sipe, in accordance with an alternative embodiment with no undulations shown on the upper member of the sipe;

FIG. 10 is a graph showing the relative improvement (reduction) in maximum yield stress (i.e., Von Mises stress) σ_{y,u}/σ_{y,o} provided by an undulating mold member 10, for different amplitudes U_{A} of a sinusoidal path P. More specifically, the graph displays maximum relative stress reductions by comparing the stress σ_{y,o} of a non-undulated mold member to the stress σ_{y,u} of an undulating mold member 10, the cross-sectional shape and dimensions of each mold member being substantially the same; as generally shown, as the amplitude U_{A} of the waveform increases, the reduction in stress also increases, in accordance with an embodiment of the present invention;

FIG. 11 is a perspective view of a mold member comprising a progressive sipe mold member with scallops and a second sipe mold member, according to an alternative embodiment of the present invention;

FIG. 12 is a graph showing the force versus displacement curves measured experimentally while demolding progressive sipe mold members having different configurations as shown by FIGS. 13A-13C;

FIG. 13A is a perspective view of a bank of sipe mold members having a first configuration with undulations only along the sweep axis used in the test trials shown in the graph of FIG. 12;

FIG. 13B is a perspective view of a bank of sipe mold members having a second configuration with undulations along the sweep axis and the upper member used in the test trials shown in the graph of FIG. 12; and

FIG. 13C is a perspective view of a bank of sipe mold members having a third configuration with undulations along the sweep axis, undulations along the upper member, and scallops on the lower projection members that was used in the test trials shown in the graph of FIG. 12.

### DETAILED DESCRIPTION OF PARTICULAR EMBODIMENTS

Particular embodiments of the present invention provide treads containing an undulating progressive tread feature or sipe, and methods and apparatus of forming the same.

A progressive sipe is a sipe that generally includes a pair of projections extending downwardly from an upper sipe portion positioned along a tread contact surface, at least one of the projections extending outwardly from the upper sipe portion. The tread contact surface is generally the portion of the tread extending about the outer circumference of a tire between the side edges of the tread. At least one of the pair of projections also extends outwardly or away from the other projection as each extends downwardly with increasing tread depth. In particular embodiments, the lower projections extend from an upper sipe portion having a length, the upper sipe portion extending downwardly from the contact surface of the tread to a particular depth within the tread. Lower projections may extend from a bottom end of upper sipe portion, or from any other location along the length of upper sipe portion. To form progressive sipes within a tread, a corresponding mold member is positioned within the mold to form a relief. A progressive sipe mold member includes a corresponding member for each sipe extension or projection. Generally, the sipe mold member forms a sipe having substantially the same cross-sectional shape, except that the mold member corresponding to upper sipe portion may extend further to form a means for attaching mold member into a mold. Consequently, the mold member has the negative image of the sipe that is to be made.

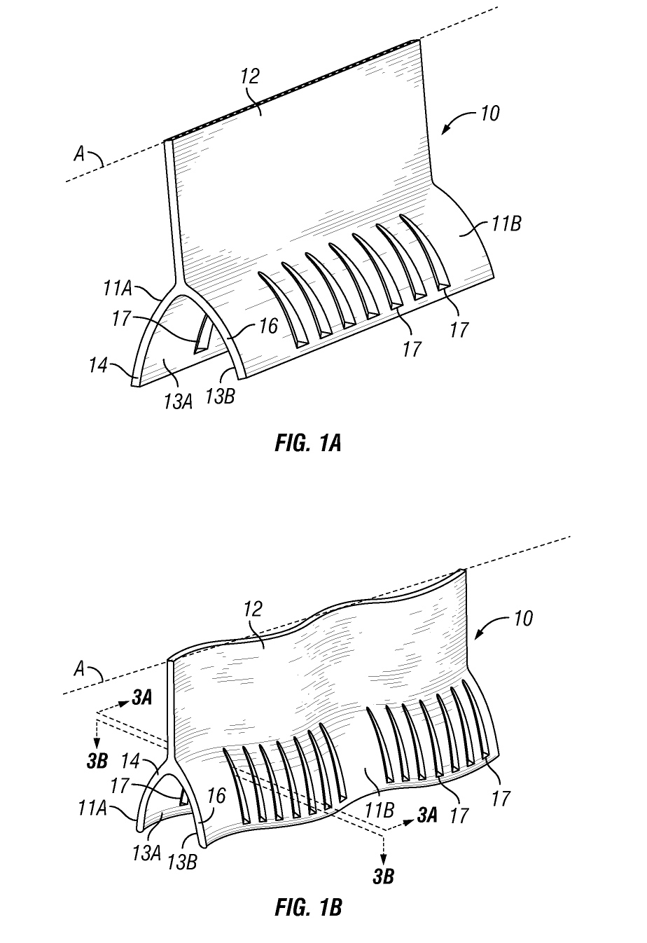

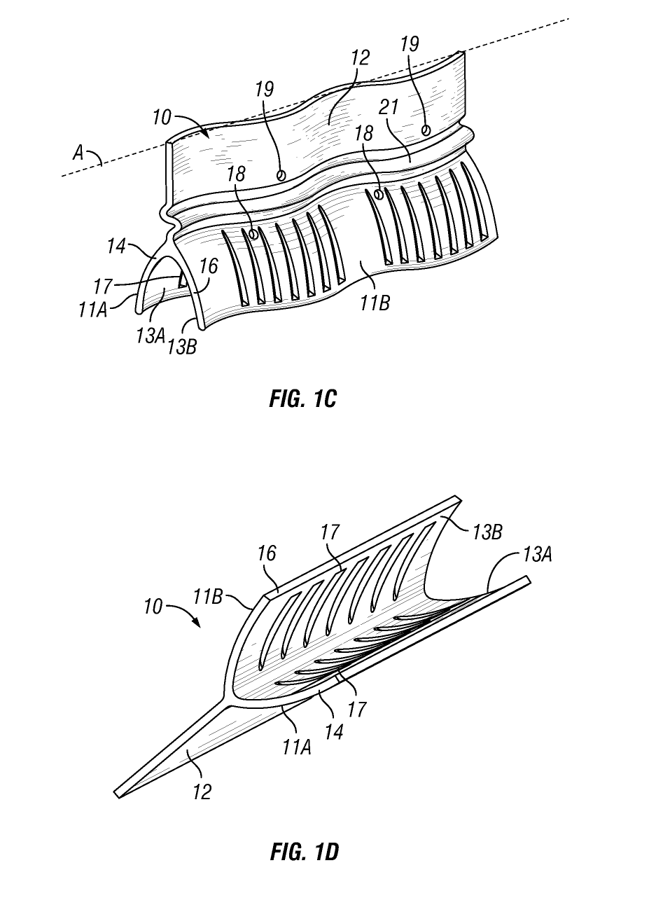

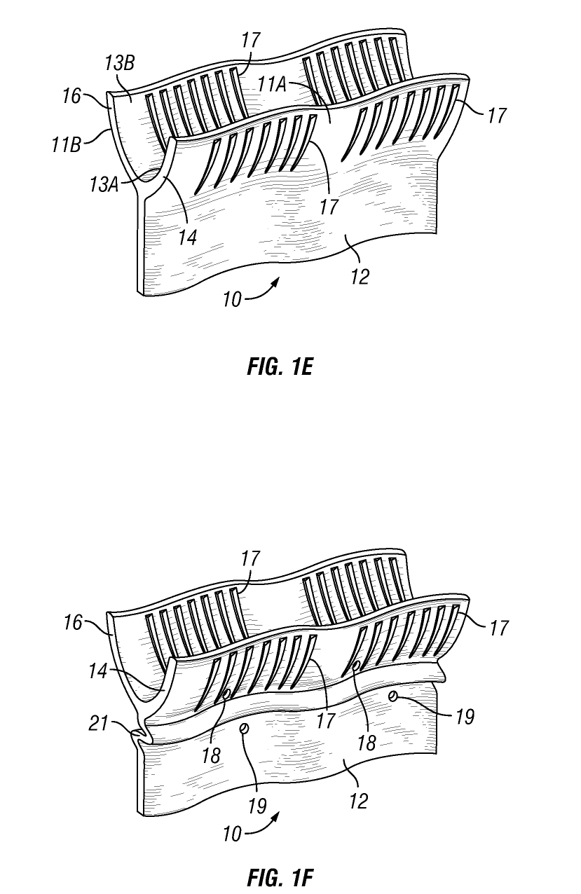

Progressive sipe mold member 10, shown in a first embodiment in FIG. 1A, includes an initial or upper member 12, and a pair of first and second lower projection members 14 and 16 extending from upper member 12. Each lower projection member 14, 16 has outward facing surfaces 11 and inward facing surfaces 13, so called because these surfaces either face outward and away from the other lower projection member or inward and toward the other lower projection member. In this embodiment, the mold member 10 extends in a straight manner along its sweep axis A and has no undulations in any direction. Instead, scallops or recesses 17 are found on the outward facing surfaces 11 of the first and second lower projection members 14, 16 (though only one outward facing surface is clearly shown in FIG. 1A, it is to be understood that similarly configured scallops are found on both outward facing surfaces). Likewise, scallops 17 are also found on the inward facing surfaces 13 as depicted in FIG. 1D. In like fashion, a second embodiment is shown in FIGS. 1B and 1E where the mold member 10 undulates along its sweep axis A and has scallops 17 found on the outward and inward facing surfaces 11, 13 of its lower projection members 14, 16. Finally, a third embodiment is shown in FIGS. 1C and 1F where the mold member 10 is similarly configured as the second embodiment except undulations 21 are found along the upper member 12 just above the lower projection members 14, 16.

Briefly without limitation to the invention, here are typical purposes and differences of these different embodiments. In certain situations where tread element stiffness in the lateral direction of the tire or sweep axis of the sipe is desirable and the depth of the progressive sipe is not great, the first embodiment shown in FIG. 1A may be a good design choice. In other instances where tread element stiffness in the lateral direction of the tire or sweep axis of the sipe is desirable and the depth of the progressive sipe is large enough that demolding the sipe could be difficult, the second embodiment shown in FIG. 1B may be a good choice. Finally, in cases where tread element stiffness is required in both the lateral and radial directions of the tire, the third embodiment shown by FIG. 1C may be a good choice. The reasons why each of these embodiments is best suited for these different applications will become more readily apparent as their detailed description progresses.

Conventional sipes, in comparison to progressive sipes, do not include a pair of lower projections. Accordingly, mold members for forming conventional sipes do not have lower extending members 14, 16, and instead generally comprise an elongated upper member 12. Accordingly, significantly less resistive forces are exerted on conventional sipe mold members during molding and demolding operations, since resistive forces are only exerted upon the very thin bottom end surface of the slit-like member, and any side surfaces that may exist when a conventional sipe mold member extends downwardly in a wavy (i.e., non-linear) path.

It follows that during molding and demolding operations, progressive sipe mold members 10 are exposed to substantially higher forces than those associated with conventional sipes. Because lower members 14, 16 extend outwardly, progressive sipe mold member 10 provides significantly more lateral surface area than a conventional sipe mold member against which a tread will apply forces and moments to resist mold member entry or extraction from such tread during mold closing and opening operations, respectively. Accordingly, significantly more force is applied against progressive mold member 10, as compared to a conventional sipe mold member.

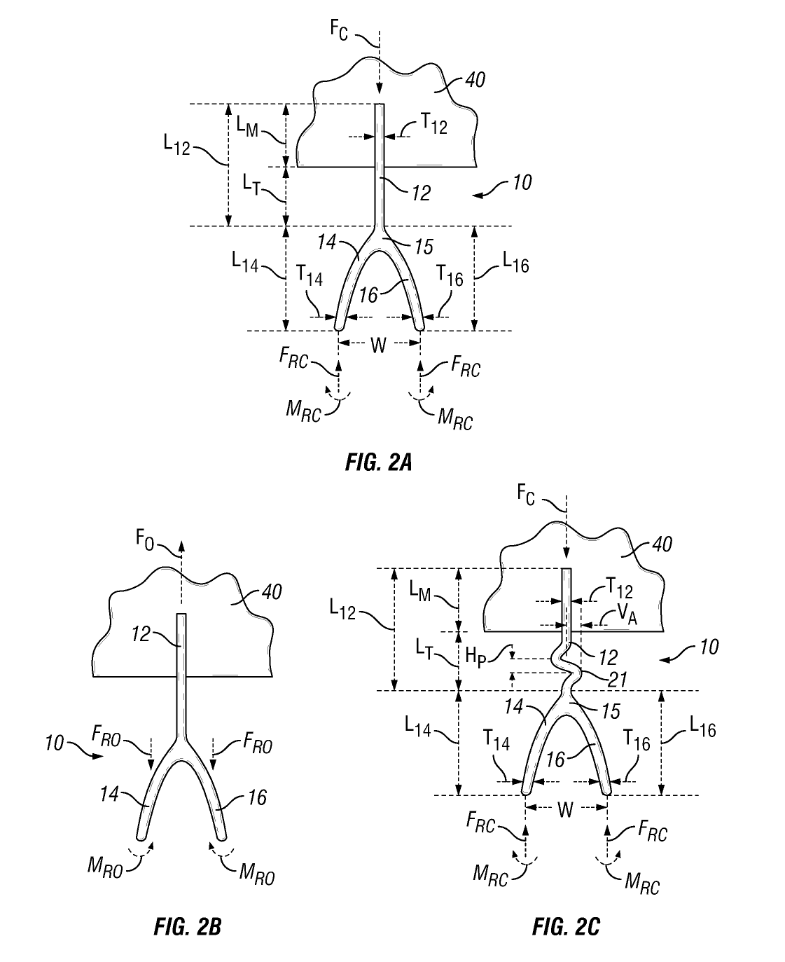

For example, with reference to FIGS. 2A and 2C, exemplary embodiments of a progressive sipe mold member 10 are shown in cross-section during a mold closing operation. When a mold 40 is closed, such as prior to molding and/or curing of the tread, the sipe mold member 10 is forced by closing force F_{C} into tread material positioned within the mold. Accordingly, the tread material resists entry of the sipe mold member 10, which imparts resistive forces F_{RC} on the lower extensions 14 and 16 of mold member 10. Further, each of the lower extension members 14, 16 is subjected to a moment M_{RC}, which arises by virtue of each such lower member 14, 16 being cantilevered from upper member 12. Similarly, as shown exemplarily in FIG. 2B, the tread exerts resistive forces F_{RO} and moments M_{RO} against the lower members 14, 16 as the tread attempts to prevent the extraction of member 10 during a mold opening operation.

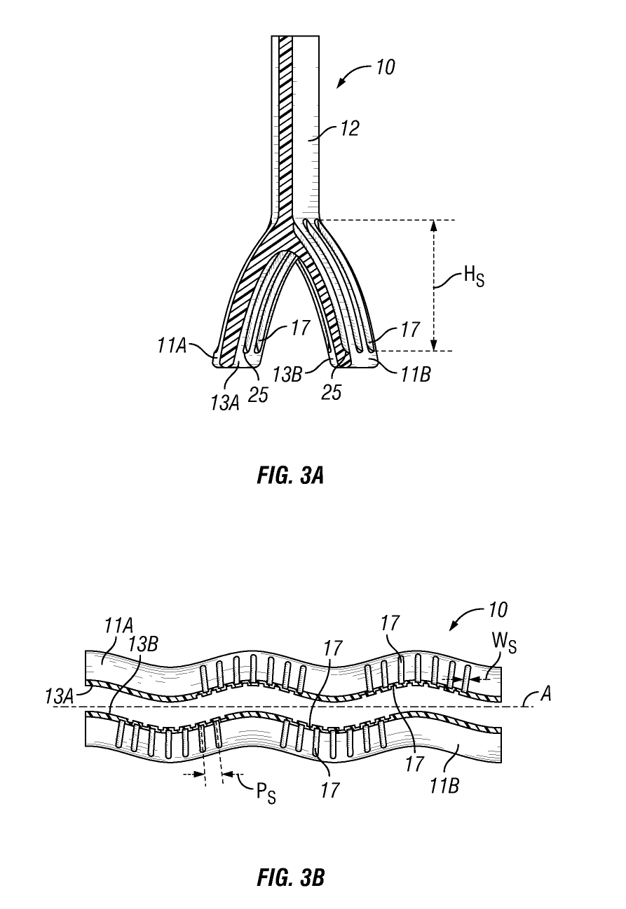

Looking at FIGS. 3A and 3B, cross-sections of the scallops 17 can be seen. As will be discussed in more detail later, the scallops 17 unexpectedly aid in the demolding of the mold member 10 since an increase in the surface area of the molding member 10 usually makes demolding more difficult. One possible explanation as to why the scallops 17 aid in demolding a mold member 10 may be that as the mold member 10 withdraws from the tread rubber 20, the ridges 23 formed in the sipes 24 by the scallops 17 found on the outward facing surfaces 11 of the mold member 10 provide a ramping motion and act like tiny pry bars that lift the majority of the surfaces of the sipe 24 that are formed by the outward facing surfaces 11 of the mold member out of contact with the mold member 10 once the ridges have exited the scallops and rest on outward facing surfaces 11 of the mold member 10, eliminating much of the friction and vacuum that tends to make demolding a molding member 10 more difficult. For the remainder of the demolding cycle, the ridges 23 act like skids that slide on the outward facing surfaces 11 of the mold member 10 and reduce friction until the demolding is completed. In situations where undulations 21 are present in the upper member 12 of the mold member 10, it is believed that the ridges 23 may also help the tread rubber 20 that is found in the undercuts formed by these undulations to withdraw via the ramping motion described above and not just only by brute force that is exerted in a demolding direction, which could cause damage to the tread rubber 20 and/or the molding member 10. It should be noted that the scallops may be configured with standard draft angles with no undercuts and a sloped surface 25 so that ridges can slide out of the scallops relatively easily (see FIG. 3A). While these are plausible explanations of why the scallops 17 and ridges 23 work, the exact mechanism is unclear and the present invention is not limited to any particular theory but to the structure that exhibits these unexpected and surprising results.

Furthermore, the ridges 23 on the opposing sidewalls of the sipes created by the scallops 17 found on the inward and outward facing surfaces 13, 11 of the lower projection members 14, 16 of the mold member 10, enhance the stiffness of a tread element in a direction parallel to the sweep axis A of the mold member 10. In particular, the scallops 17 of the mold members alternate from the inward facing surface 13 to the outward facing surface 11 of each lower projection member 14, 16, ensuring that the thickness of the lower projection member is relatively constant at 0.2 mm (approximately 0.008 of an inch) in the region where the scallops are found while the rest of the lower projection members 14, 16 and upper member 12 have a thickness of 0.4 mm (approximately 0.016 of an inch).

As can be seen in FIG. 3B, at least one scallop 17 on one surface 13 of a lower projection member is found between two scallops 17 found on the other surface 11 of the lower projection member. Consequently, the ridges 23 formed on the opposing sidewalls of the lower projections 28, 30 of the sipes 24 will have the same characteristics and will interlock when the tread is deformed, similar to the meshing of the teeth of gears so that relative movement of a tread element in any direction that is parallel to the sweep axis A of the sipe 24 is limited. This increases the overall stiffness of the tread element once it is in the contact patch. Of course, the thickness of the sipe 24 and mold member 10 can be varied in both regions that have and do not have scallops 17 in any suitable manner to achieve the tread element stiffness that is desired and to maintain the ability to mold and demold the sipe geometry. Also the width of each scallop W_{S}, height of each scallop H_{S} and pitch P_{S} between each scallop can be varied as needed. As shown in FIG. 3B, W_{S} is 0.55 mm (approximately 0.102 of an inch), H_{S} is approximately 90% of the height of the lower projection member and P_{S} is 1.31 mm (approximately 0.052 of an inch).

As generally shown in FIGS. 2A and 2C, lower members 14, 16 each have a corresponding length τ₁₄, τ₁₆ and extend outwardly to a width W. In the embodiments shown, upper sipe mold member 12 has a length τ₁₂. With reference to FIGS. 2A and 2C, length τ₁₂ of upper sipe mold member 12 is equal to the sum of distance τ_{M} and τ_{T}, where distance τ_{M} represents a distance by which upper sipe mold member 12 is inserted into a mold 40 and distance τ_{T} represents the distance by which upper mold sipe mold member 12 is inserted into tread 20. Distances τ_{M} and τ_{T} may be any desired value. For example, upper sipe mold member 12 may not extend into the tread, and, therefore, distances τ_{T} would equal zero. In other words, upper sipe mold member 12 simply comprises the joint 15 between lower members 14, 16, such that upper sipe mold member 12 does not substantially extend upwardly beyond such joint 15. In the embodiments shown, each of the lower members 14, 16 extend from upper member 12 at a common instance, namely, at joint 15, at the bottom end of upper member 12. In other embodiments, however, it is contemplated that each of the lower extension members 14, 16 may extend independently from upper member 12, from the same or different position along length τ₁₂ of upper member 12.

In certain cases as shown by FIG. 2C, one or more undulations 21 may be found just above the joint 15, stopping approximately 2 mm (approximately 0.079 of an inch) below the attachment to the mold. The length of the undulations is roughly equal to the length τₜ of the upper member 12 that extends into the tread minus a suitable distance above the joint 15 and below the attachment to the mold 40, such as a few millimeters in total. Furthermore, the amplitude V_{A} and half pitch H_{P} may be 1.0 mm (approximately 0.039 of an inch) with the undulations 21 beginning at the joint 15. Of course the dimensions and position of these undulations 21 can be varied as desired. For example, the half pitch H_{P} could range from 0.77 to 1.0 mm (approximately 0.030 to 0.039 of an inch) and the amplitude V_{A} typically ranges from 0.5 to 1.0 mm (approximately 0.0195 to 0.039 of an inch). Also, the shape of the undulations can differ than what is shown and may have similar configurations as is described hereafter for the undulations that extend along the sweep axis A of the mold member 10. Of course, the opposing sidewalls of the upper portion of the sipe formed by such a mold member will have a complimentary shape and undulate.

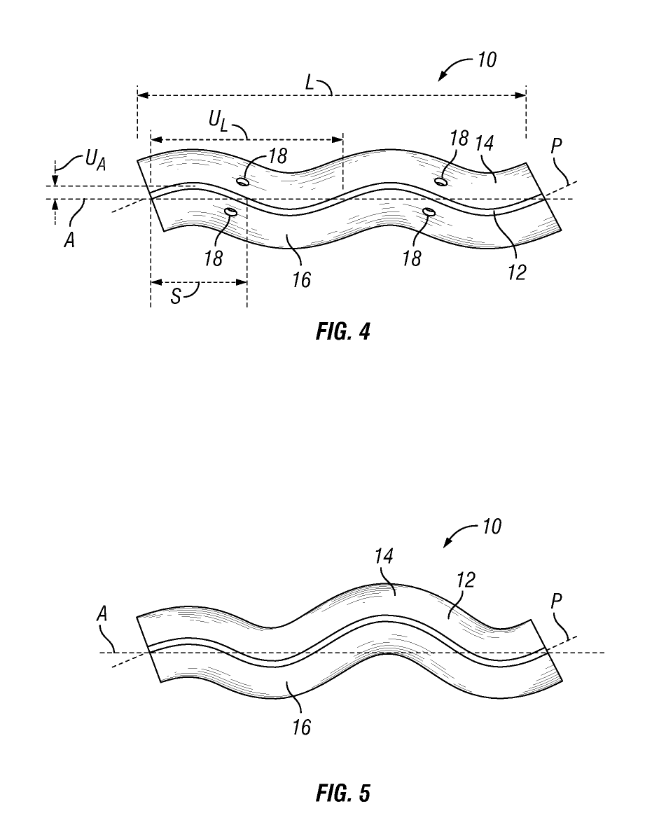

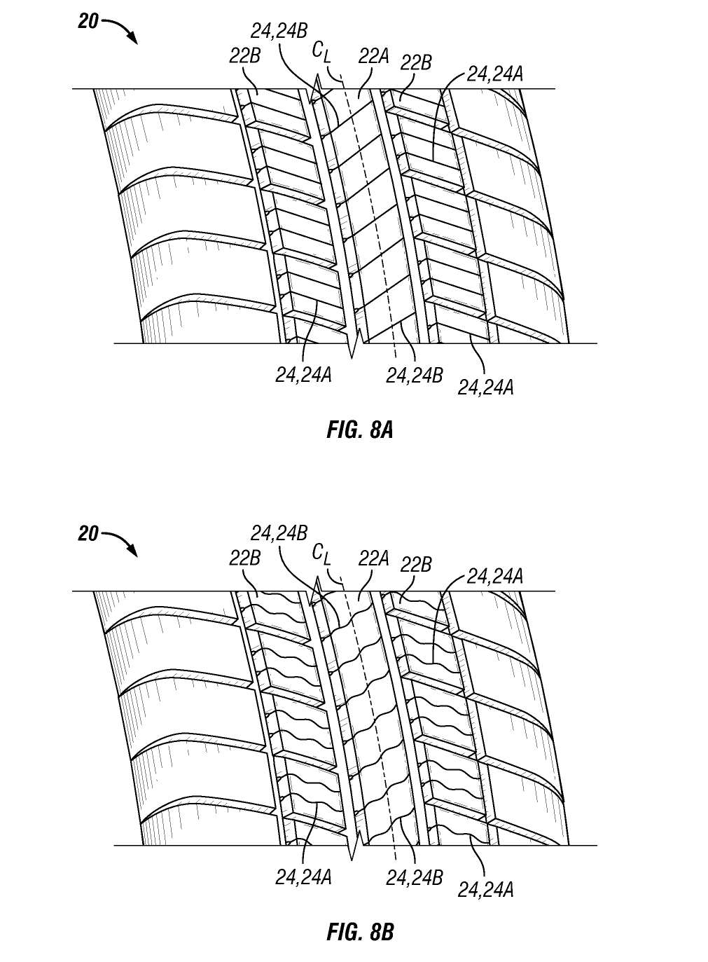

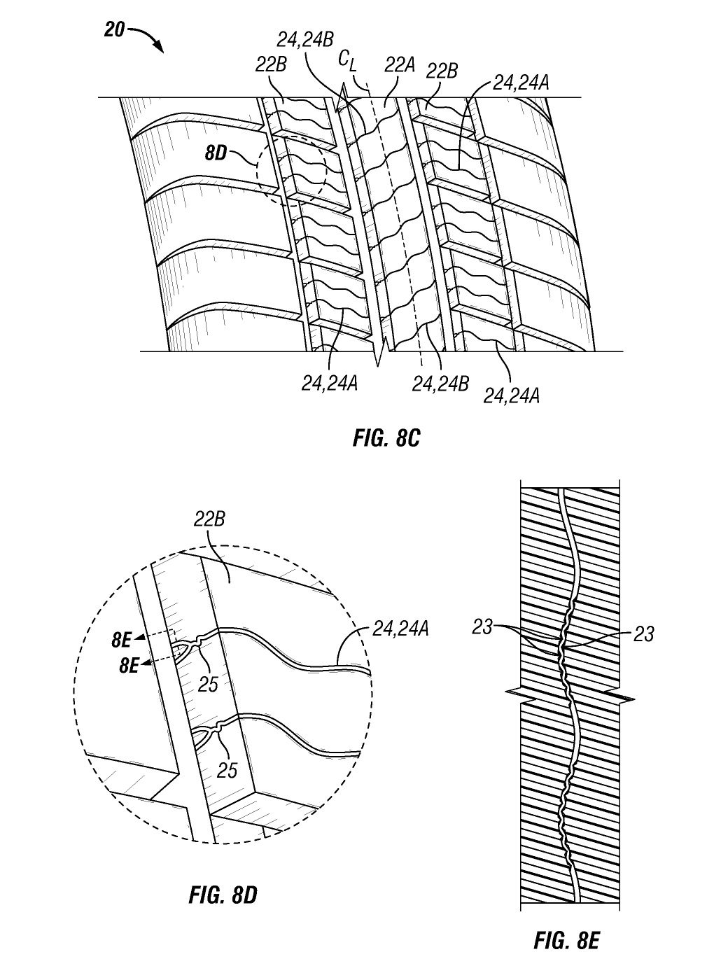

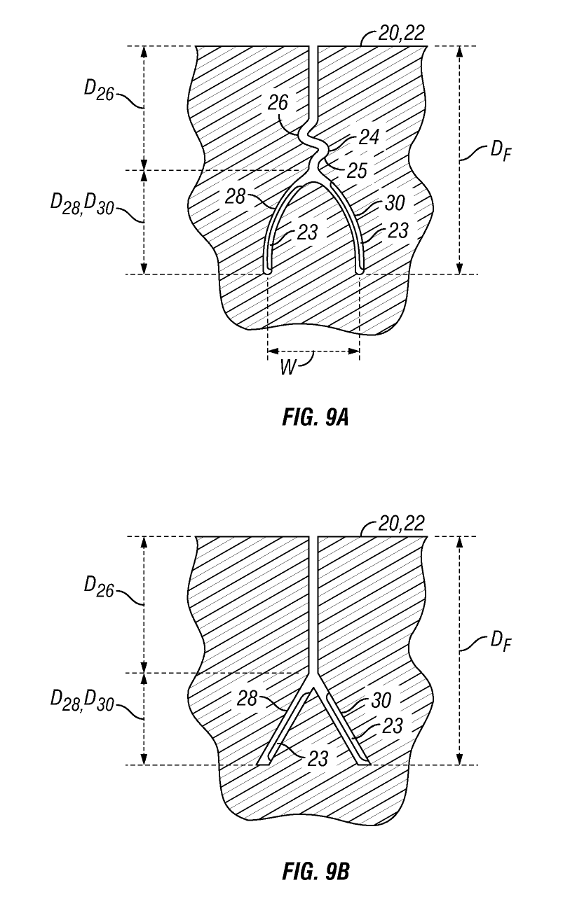

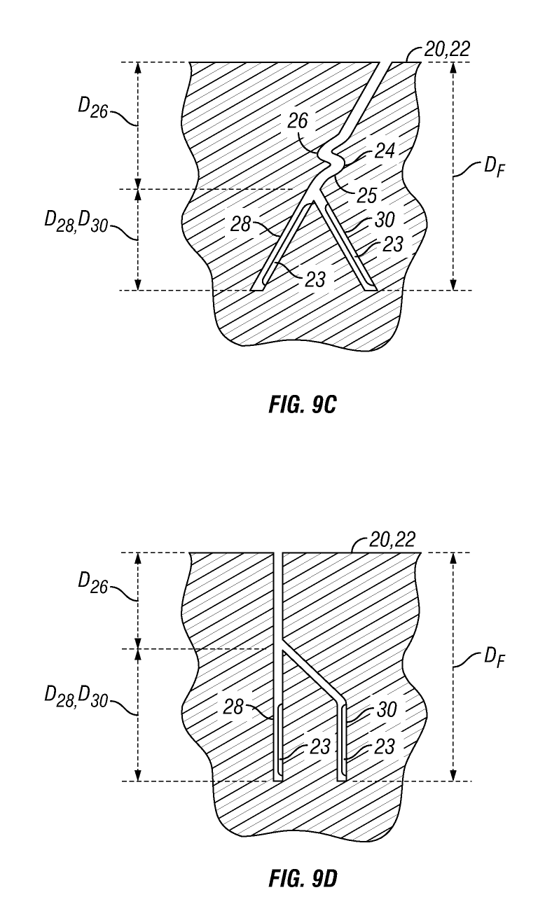

As exemplarily shown in FIGS. 1B, 1C and 4, to overcome the additional forces and stresses experienced by a progressive sipe mold member 10, such member 10 is strengthened by undulating the member 10 along its length L, relative to a sweep axis A extending in a generally lengthwise direction of member 10. In other words, sipe mold member 10, and any corresponding sipe 24 formed from member 10 (such as is shown, for example, in FIGS. 8-9D), alternates between opposing sides of a sweep axis A in any desired manner for a length L of the corresponding member 10 or sipe 24. Accordingly, member 10 extends along a path P, which extends along sweep axis A in an undulating or non-linear manner. With reference to FIG. 4, each undulation segment S extends along sweep axis A by a distance equal to one-half (½) the length U_{L}.

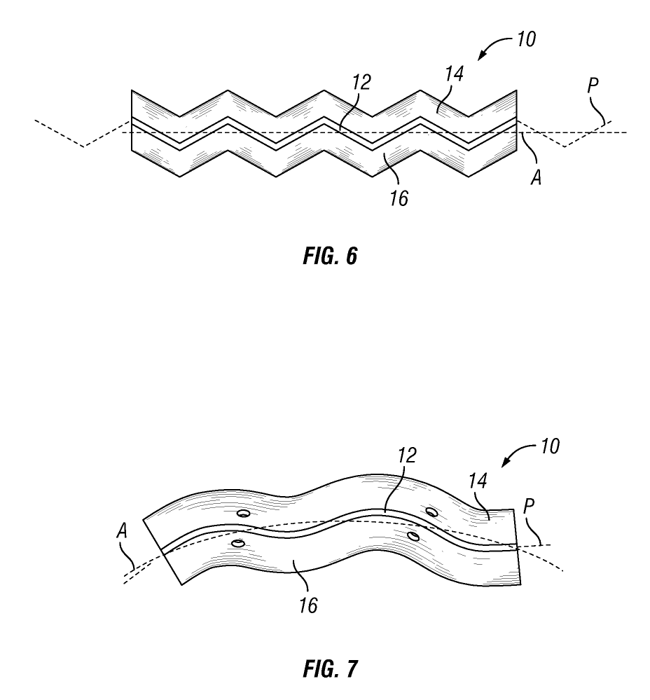

As shown in FIGS. 1B, 1C and 4, in particular embodiments, an undulating path P may be symmetrical about axis A. As shown in FIG. 5, however, it is contemplated that member 10 may extend along an undulating path P that is not symmetrical (i.e., asymmetrical) relative to sweep axis A. It is contemplated that undulating path P may extend as a smooth waveform or a contoured path, such is exemplarily shown in FIGS. 1B, 1C, 4 and 5. For example, a waveform may comprise a sinusoidal wave having a periodic length that is equal to length U_{L}, and an amplitude equal to distance U_{A}. In other embodiments, undulating path P may extend in a stepped (i.e., jagged) path, which may be formed of linear or non-linear step undulation segments S. A linearly-stepped path P is exemplarily shown in FIG. 6. It is contemplated that an undulating path P may only exist or extend along a portion of a sipe mold member 10, and/or may be combined with differently undulating portions of sipe mold member 10. For example, a sipe mold member 10 may include intervals of contoured and stepped undulations. Further, the extension of path P may extend along length L in a consistent or uniform manner, as shown in FIGS. 1B, 1C and 4, or in an intermittent, variable, non-repeating, or arbitrary manner, meaning that the path P may undulate inconsistently or intermittently along path P.

Sweep axis A generally extends along a length L of a sipe mold member 10 or corresponding sipe 24. As generally shown in FIGS. 1-6, sweep axis A may be linear. In other embodiments, however, sweep axis A may extend in a non-linear direction, such as is shown in one embodiment in FIG. 7.

By providing undulating lower members 14, 16, each is better able to (i.e., more efficiently able to) withstand the forces exerted thereupon when mold member 10 is forced in and out of a tread during the molding process. Accordingly, it is contemplated that lower members 14, 16 may undulate while upper member 12 does not undulate. It is also contemplated that members 12, 14, 16 may undulate differently and independently, or together in any combination. Members 12, 14, 16 are shown in particular embodiments to undulate together in FIGS. 1B, 1C, 4 and 5.

In one embodiment, a sinusoidal path P has a periodic length U_{L} of 10 mm and an amplitude U_{A} of 0.3 mm (approximately 0.012 of an inch), 0.4 mm (approximately 0.016 of an inch), or 0.6 mm (approximately 0.024 of an inch). In other embodiments, the amplitude U_{A} is 0.3-0.6 mm (approximately 0.012-0.024 of an inch) or 0.4-0.6 mm (approximately 0.016-0.024 of an inch). In still other embodiments, the amplitude U_{A} is at least 0.3 mm (approximately 0.012 of an inch), at least 0.4 mm (approximately 0.016 of an inch), or at least 3% of the periodic length U_{L}. According to a study, when the sinusoidal path P of a mold member 10 has a periodic length U_{L} of 10 mm (approximately 0.39 of an inch) and an amplitude U_{A} of 0.6 mm (approximately 0.024 of an inch), it has been estimated that the maximum yield stress (i.e., Von Mises stress) was reduced by a factor of 2.5 when compared to the maximum yield stress of a non-undulating mold member having the substantially the same cross-sectional shape and dimensions. However, when reducing the amplitude U_{A} from 0.6 mm to 0.4 mm (approximately 0.024 to 0.016 of an inch), the maximum yield stress was reduced by a factor 2.

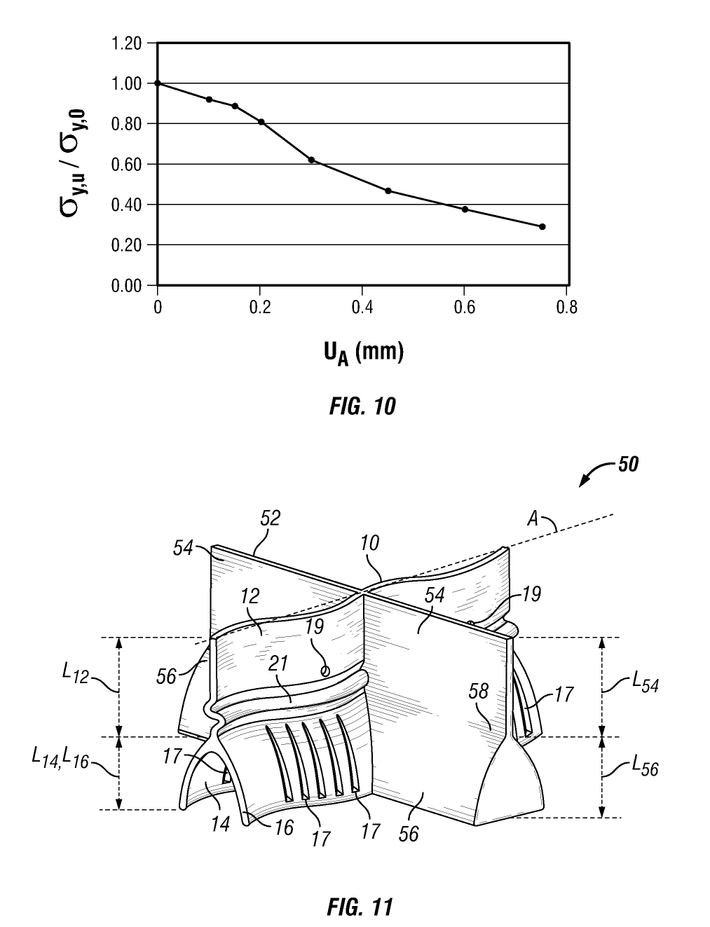

In FIG. 10, a graph more generally shows the relative improvement (reduction) in maximum yield stress (i.e., Von Mises stress) provided by an undulating mold member 10, for different amplitudes U_{A} of a sinusoidal path P. More specifically, the graph displays maximum relative stress reductions by comparing the stress of a non-undulated mold member to an undulating mold member 10, the cross-sectional shape and dimensions of each mold member being substantially the same. In the graph, the comparison of maximum yield stresses is represented by relative maximum yield stress σ_{y,u}/σ_{y,o}, which is equal to the maximum yield stress σ_{y,u} of an undulating sipe mold member 10 divided by the maximum yield stress σ_{y,o} of a non-undulating sipe mold member. As generally shown in FIG. 10, the reduction in stress increases as the amplitude U_{A} of the waveform increases.

By achieving increased strength and durability by reducing the stresses through undulations, the thickness t₁₂, t₁₄, and t₁₆ of respective undulating members 12, 14, 16 may be reduced to improve the performance of a resulting sipe in a tire tread, as well as the corresponding tire tread. With reference to the embodiment of FIGS. 2A and 2C, thicknesses t₁₂, t₁₄, and t₁₆ are shown. Such thicknesses may vary along the length L of member 10, and may vary between each other. In particular embodiments, any thickness t₁₂, t₁₄, and t₁₆ may be 0.4 mm (approximately 0.016 of an inch) or lower, and in other embodiments, 0.3 mm or lower (approximately 0.012 of an inch), 0.2 mm (approximately 0.008 of an inch) or lower, and 0.1 mm (approximately 0.004 of an inch) or lower. In particular embodiments, any thickness t₁₂, t₁₄, and t₁₆ may be 0.05-0.4 mm (approximately 0.002-0.016 of an inch), and in other embodiments, 0.05-0.3 mm (approximately 0.002-0.012 of an inch) or 0.05-0.2 mm (approximately 0.002-0.008 of an inch). Further, with regard to width W, it may extend any distance. In particular embodiments, width W is approximately equal to 3-8 mm (approximately 0.12-0.32 of an inch), and in more specific embodiments, 5-6 mm (approximately 0.2-0.24 of an inch).

To facilitate attachment of progressive mold member 10 into a mold, member 10 may include one or more attachment means. In particular embodiments, as exemplarily shown in FIGS. 2A, 2B and 2C, the upper portion of upper member 12 is an attachment means, as such may be inserted into the mold 40 for securement, such as by welding. Further as shown by FIG. 1C, an attachment means may also comprise one or more apertures 19 positioned along upper member 12 to facilitate the securement of aluminum or other metal about a portion of upper member 12 for welding member 10 within an aluminum mold. Any other attachment means known in the art may be used in addition to, or in lieu of, upper member 12 and/or apertures 19. Further, vents 18 may be included within any bottom member 14, 16 to facilitate the venting of air or rubber through a corresponding member 14, 16.

Undulated sipe mold members 10 are utilized to form corresponding progressive sipes 24 in a tire tread. With reference to FIGS. 8A thru 8C, a representative tread 20 is shown having undulating progressive sipes 24 formed by similarly-shaped mold members 10. In the embodiment shown, progressive sipes 24 are formed within tread elements 22, which may comprise a rib 22a or a block 22b. The sipes 24 may be used and oriented within a tread 20 in any manner desired to achieve a desired tread pattern. Accordingly, each sipe 24 may extend along its sweep axis A in any direction along a tread element 22, where such sweep axis A is linear or non-linear. In FIGS. 8A thru 8C, for example, sipes 24 are provided along a tread in a particular embodiment, where sipes 24a extend along blocks 22b and sipes 24b extend along ribs 22a. More specifically, sipes 24a are shown to extend laterally along tread 20 in a direction approximately normal to the longitudinal centerline C_{L} of tread 20, while sipes 24b extend laterally at a biased angle relative to the tread longitudinal centerline C_{L}. Sipe 24 may also extend circumferentially about a tire, where the length L of sipe 24, or of corresponding mold member 10, is equal to the length or circumference of the tread. Or, it can also be said that such sipe 24, or mold member 10, is continuous. In other embodiments, undulated sipes 24 may extend across a full width (or length) of a corresponding tread element 22, such as is exemplarily shown in FIG. 8A thru 8C, or, in other embodiments, a sipe 24 may extend along any portion less than the full width or length of any tread element 22.

Focusing on FIG. 8A, a progressive sipe that has no undulations in its upper section or along its sweep axis that is formed by a mold member similar to what is depicted in FIG. 1A is shown. Looking at FIG. 8B, a progressive sipe that has no undulations in its upper section but does have undulations along its sweep axis that is formed by a mold member as shown by FIG. 1B is illustrated. Finally looking at FIGS. 8C and 8D, a progressive sipe that has undulations in its upper section and along its sweep axis that is formed by a mold member as illustrated by FIG. 1C is shown.

With reference to FIGS. 9A-9D, a sipe 24 generally extends to any depth D_{F} into the depth of a tire tread. In particular embodiments, such as those shown in such figures, the sipe 24 may comprise an upper or initial portion 26, which corresponds to initial or upper member 12 of mold element 10 and may or may not have undulations 25. As with upper member 12, it is contemplated that upper portion 26 may or may not undulate. The sipe 24 also includes first and second lower projections (i.e., legs) 28, 30, each of which correspond to first and second mold members 14, 16, respectively. In particular embodiments, upper portion 26 extends downwardly from an exterior tread surface to a desired tread depth D₂₆. Depth D₂₆ corresponds to length l₁₂ of an associated mold member 10. While depth D₂₆ may comprise any distance, it is also contemplated that depth D₂₆ may be substantially zero, such that joint 15 extends along the tread surface. With regard to lower projections 28, 30, each such projection extends a depth D₂₈ and D₃₀, respectively, into the tread. Such projections 28, 30 may extend to the same tread depth as shown in the figures, or, in other embodiments, may each extend to different depths within the tread.

With regard to the cross-sectional shape of progressive sipe 24, any shape is contemplated. With general reference to the embodiments of FIGS. 9A-9D, the cross-sectional shape of a progressive sipe 24 can be generally described as being an inverted “Y” or “h”. Still, it is contemplated that any other shape or variation can be used, and, accordingly, is within the scope of this invention. For example, with reference to the embodiment shown in FIG. 9A, the cross-section of sipe 24 shown can also be referred to as forming a wishbone shape. Further, lower projections 28, 30 generally form an inverted “U” or “V” shape. It follows that sipe 24 may form a “U” or “V” shape when upper portion does not exist, or when it has a small or negligible length. With reference to the embodiments shown in FIGS. 9B and 9C, the cross-sections of sipe 24 shown can also be referred to as forming lower case and upper case inverted “Y” shapes, respectively. With reference to FIG. 9D, the cross-section shown can also be referred to as forming a lower case “h” shape. The cross-sectional shape of sipe 24 may be symmetrical, as exemplarily shown in FIGS. 9A and 9B, or asymmetrical, as exemplarily shown in FIGS. 9C and 9D. Because the sipe 24 is formed by a corresponding mold member 10, it follows that any variations in shape or design, including the manner or path of undulation, for either sipe 24 or member 10 corresponds to the other. Accordingly, the discussion with regard to mold member 10, as well as associated members 12, 14, 16, is incorporated within regard to sipe 24 and its projections 26, 28, 30, and visa versa. Accordingly, just as sipe mold member 10 has a sweep axis A, the corresponding sipe 24 formed by such mold member 10 also extends along the same (has a corresponding) sweep axis A.

In operation, upper projection 26 provides an initial sipe incision along the tread surface, which can be seen in FIGS. 8A thru 8D. After the tire tread has been worn to a particular depth, the upper sipe incision is worn away by a depth D₂₄ to leave exposed a pair of spaced-apart sipe incisions associated with first and second projections 28, 30. It is contemplated that, however, sipe mold member 10 may be arranged such that only the first and second lower mold members 14, 16 are contained within tread 20, which means that only first and second projections 28, 30 would be contained within an unworn tread. In other words, distance τ_{T}, as shown in FIGS. 2A and 2C, would be equal to zero.

It should be noted that only one ridge 23, formed by a scallop 17 of a mold member 10, which is found on the outside wall of lower projection 30 and only one ridge 23 that is found on the inside wall of lower projection 28 are shown in FIGS. 9A thru 9D for clarity and that in actuality, ridges 23 would alternate from the inside to the outside walls of the lower projections 28, 30 so that the ridges 23 interlock as previously described as is best shown by FIG. 8E. Thus, the geometry of the ridges/sipes is the negative image of what is shown in FIG. 3B. This construction enhances the rigidity of the tread element.

With reference to FIG. 11, another embodiment of the present invention is shown. It is contemplated that an undulated sipe 24 may intersect any other tread feature, such as another groove or sipe, for example. In FIG. 11, a multi-feature mold member 50 is shown. The multi-feature member 50 generally includes an undulated sipe mold member 10 intersecting a second tread feature mold member 52. Undulating mold member 10 may comprise any embodiment contemplated above, and may intersect second mold member 52 at any angle of incidence. Second mold member 52 may form a groove or sipe, which may extend in any direction along a tread. For example, second mold member 52 extends in any direction including a lateral or circumferential direction along a tread. In the particular embodiment shown in FIG. 10, second mold member 52 generally includes an upper mold portion 54 and a lower mold portion 56, the lower portion 56 extending from upper portion 54 at location 58 while also expanding widthwise from the upper mold portion 54 (i.e., the lower portion 56 is wider than the upper mold portion 54). In the embodiment shown, lower portion 56 forms a single oblong or tear-drop shaped form, which may have an outer shape similar to that formed by the pair of lower projection members 14, 16 of member 10, or, in other embodiments, lower portion 56 may for any other desired shape. In other embodiments, second mold member 52 may comprise a second undulating mold member 10, or a conventional sipe, which generally comprises an elongated upper portion 54, which may extend downwardly any distance, where such downward extension may be linear or non-linear.

As shown in the embodiment of FIG. 11, upper mold portion 54 extends a distance τ₅₄ between a top and a bottom of such mold portion 54, while bottom mold portion 56 extends a distance τ₅₆ between a top and a bottom of such mold portion 56. In particular embodiments, upper mold portion distance τ₅₄ equals at least 2 mm (approximately 0.079 of an inch), and the lower wear layer formed by lower mold portion 56 in a tread becomes exposed after distance τ₅₄ is worn away. In other embodiments, any other desirable distances for distance τ₅₄ and distance τ₅₆ may be used. Further, while lower projections 14, 16 of progressive sipe mold member 10 and lower mold portion 56 of second mold member 52 as shown in FIG. 11 to extend (or initiate) from similar locations along corresponding members 10 and 52 (i.e., locations 15 and 58 are similarly positioned along the height of member 50), in other embodiments, lower projections and lower mold portion 56 may begin to extend (initialize) at different locations along the height of member 50. Finally, the projections lengths τ₁₄, τ₁₆ and lower portion length τ₅₆ may be the same, as shown in FIG. 11, or different, in other embodiments. Also, scallops 17 may found on either, both, or none of the lower portions of the mold members 10, 52 and undulations may be found on either, both or none of the upper portions of the mold members 10, 52.

Any of the embodiments of the mold members discussed herein may be manufactured using a laser sintering (selective laser melting process) or other rapid prototyping technology (such as micro-casting) that allows complex geometry including the lower projection members with scallops to be created. When using such a technology, it is possible that the mold member can have any desirable shape. In particular, the technology disclosed in U.S. Pat. No. 5,252,264 can be used to make the mold members. The content of this patent is incorporated herein by reference in its entirety.

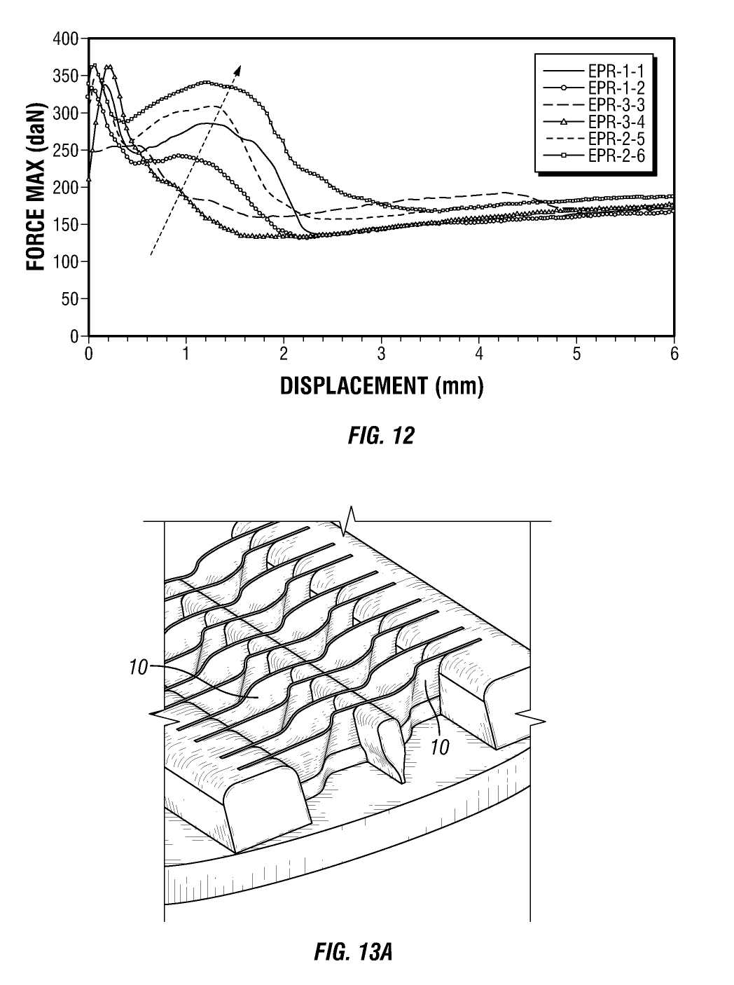

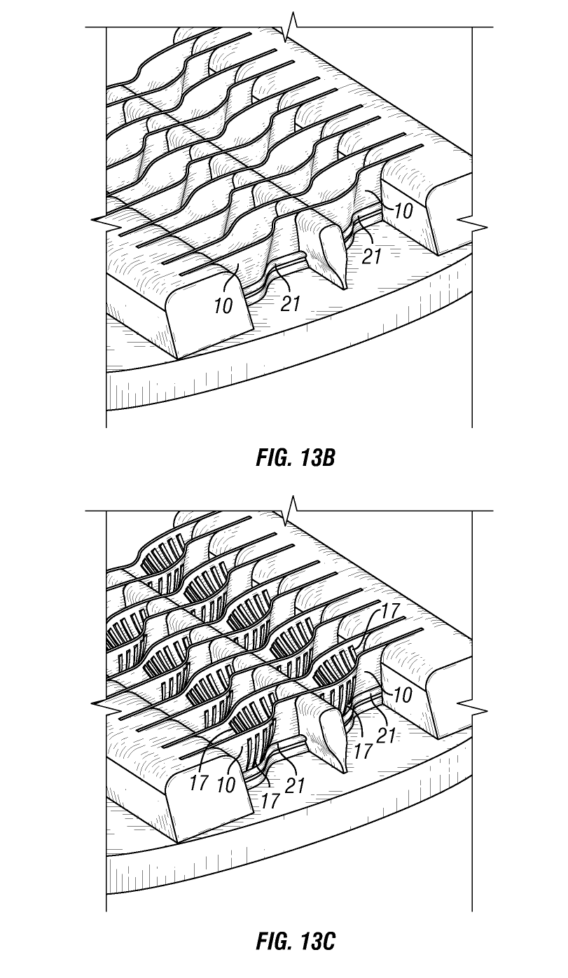

Turning your attention to FIG. 12, this graph shows the improved demolding of progressive sipe mold members by implementing the scallops described herein. Two test trials (designated as EPR-1-1 and EPR-1-2) were first conducted on a bank of progressive sipe mold members 10 that undulate along their sweep axis as shown by FIG. 13A. Both trials show a maximum force of about 340 daN at 0.1-0.2 mm displacement (approximately 764 lbf at 0.004-0.008 of an inch displacement) during the demolding operation. Then the molding force lowers to about 250 daN at 0.4 mm displacement (approximately 562 lbf at 0.004-0.008 of an inch displacement) and stays relatively constant until 1-1.4 mm displacement (approximately 0.039-0.055 of an inch displacement) is reached and then drops to about 130 daN at 2-2.2 mm displacement (approximately 292 lbf at 0.079-0.087 of an inch displacement) and remains relatively constant till the end of the demolding cycle. Next, another two trials (designated as EPR-2-5 and EPR-2-6) were conducted on another bank of progressive sipe mold members 10 that have the identical configuration as the first configuration except that these mold members have undulations 21 along their upper member as well as shown by FIG. 13B. As expected, since the surface area of these mold members is larger than the first configuration, the demolding force is greater. For both test trials, the peak force was 350 daN or greater at 0.1-0.2 mm displacement (approximately 786 lbf at 0.004-0.008 of an inch displacement) and then dipped to 300-250 daN at 0.4 mm displacement (approximately 674-562 lbf at 0.016 of an inch displacement). The force then rose to 300-330 daN at 1.2 mm (approximately 674-742 lbf at 0.047 of an inch displacement) and dropped to 150 daN at 3 mm displacement (approximately 337 lbf at 0.117 of an inch displacement) and remained constant for the rest of the demolding cycle. Finally, another two trials (designated as EPR-3-3 and EPR-3-4) were conducted on a bank of mold members 10 that had the same configuration as the second configuration except that scallops 17 were added to the lower projection members as shown by FIG. 13C.

One of ordinary skill in the art would expect that the work necessary to demold these mold members would be the greatest of all three configurations because of the increased surface area; however, this was not the case. Instead, the area under the force displacement curve, which represents the amount of work necessary to demold these mold members, was the least of all three configurations. In particular, the peak force at 0.2-0.3 mm displacement (approximately 0.008-0.012 of an inch displacement) was more than the first configuration and the same as the second configuration but starting at about 0.6-0.8 mm of displacement (approximately 0.024-0.031 of an inch displacement), the force necessary to demold the third configuration was less than the second and was less than or equal to the first configuration. One explanation for this is that the ridges formed by the scallops help to spread the sipe apart to help the demolding of the mold member. Although different explanations exist as to why this phenomenon happens, this invention is not limited to the mechanism of any one particular explanation and is related solely to the structure that creates these surprising benefits.

These test results indicate that the use of scallops on all progressive sipe mold members will reduce the force necessary to demold the sipe and is therefore effective in achieving the molding and demolding of progressive sipes. Advantageously, these scallops also provide a way to increase the lateral stiffness of a tread element without detracting from the ability to mold the sipe. Lastly, features that add stiffness to the tread element in the radial direction of the tire can be used in conjunction with the scallops without making the sipes impossible to mold and demold.

While this invention has been described with reference to particular embodiments thereof, it shall be understood that such description is by way of illustration and not by way of limitation. Accordingly, the scope and content of the invention are to be defined only by the terms of the appended claims.

What is claimed:

1. A sipe mold member for use in a mold comprising:
an upper mold member extending downwardly from a top end to a bottom end; and,
a first lower projection member and a second lower projection member, each lower member extending downward from the upper mold member and having a outward facing surface and inward facing surface, said first lower projection member having outward and inward facing surfaces with recesses thereon.

2. The mold member of claim 1, wherein the second lower projection member has recesses on its outward and inward facing surfaces.

3. The mold member of claim 1, wherein the recesses on the outward facing surface and the inward facing surface of the first lower projection have an alternating pattern with at least one recess on one surface being found in between two recesses located on the other surface.

4. The mold member of claim 1 wherein said recesses have at least one sloped surface found in their interior to help the demolding of the sipe mold member.

5. The mold member of claim 1, wherein the sipe mold member has a sweep axis along which the sipe mold member undulates in a desired path.

6. The mold member of claim 5, wherein the undulating path is a contoured path.

7. The mold member of claim 1, wherein the first and second lower projection members form a symmetrical cross-sectional shape.

8. The mold member of claim 1, wherein the first and second lower projection members form a “U” or “V” cross-sectional shape.

9. The mold member of claim 1, wherein the sipe mold member generally forms an inverted “Y” or “h” cross-sectional shape.

10. The mold member of claim 1, wherein the sipe mold member intersects a groove mold member or second sipe mold member.

11. The mold member of claim 1, wherein the upper mold member comprises an undulation.

12. A tire having a molded tire tread comprising:
a plurality of tread elements being separated by one or more grooves;
one or more progressive sipes in a tread element, each sipe also including:
a first and second lower sipe projection extending from an upper sipe portion, each of the projections being spaced apart from the other within the tread and extending to a depth within the tread, said first and second lower sipe projections having opposing side walls, said first lower sipe projection having ridges on its opposing sidewalls.

13. The tire of claim 12 wherein the second lower sipe projection has ridges on its opposing sidewalls.

14. The tire of claim 13 wherein the ridges on the opposing sidewalls of the first lower projection have an alternating pattern with at least one ridge on one sidewall being found between two ridges located on the other sidewall.

15. The tire of claim 12 wherein each sipe has a sweep axis along which the sipe undulates in a desired path.

16. The tire of claim 12, wherein the upper sipe portion extends from an exterior tread contact surface to a final depth within the tread, the first and second extensions extending from the upper sipe portion.

17. The tire of claim 15, wherein the undulating path is an alternating path.

18. The tire of claim 12, wherein each of the first and second projections extend to a different depth within the tread.

19. The tire of 12, wherein the upper sipe portion includes opposing sidewalls that undulate.
